(19) United States
(12) Patent Application Publication
(10) Pub. No.: US 2023/0321746 A1
(43) Pub. Date: Oct. 12, 2023

(54) ROBOTIC WELDING SYSTEM

(71) Applicant: FANUC CORPORATION, Yamanashi (JP)

(72) Inventor: Yuuichi MATSUDA, Yamanashi (JP)

(73) Assignee: FANUC CORPORATION, Yamanashi (JP)

(21) Appl. No.: 18/044,154

(22) PCT Filed: Oct. 26, 2021
(86) PCT No.: PCT/JP2021/039428

§ 371 Date: Mar. 6, 2023

(30) Foreign Application Priority Data
Oct. 30, 2020 (JP) 2020-183224

(51) Int. Cl. B23K 9/12; B25J 11/00

(52) U.S. Cl. CPC B23K 9/126; B25J 11/005

(57) ABSTRACT

Provided is a robotic welding system with which welding can be appropriately carried out even when the amount of a gap largely changes and when welding occurs at a high speed. A robotic welding system according to one aspect of the present disclosure includes: a welding torch; a gap detector configured to detect in advance a gap amount between welding targets in front of the welding torch; a robot moving the welding torch and the gap detector; a controller configured to cause a welding condition to change based on the gap amount detected in advance by the gap detector; and a welding power source configured to execute welding based on the welding condition instructed by the controller. Before the welding torch reaches a position at which the gap amount starts to exhibit an increasing tendency, the controller causes the welding condition to change according to an increase in the gap amount, and after the welding torch passes a position at which the gap amount starts to exhibit a decreasing tendency, the controller causes the welding condition to change according to a decrease in the gap amount.

### TECHNICAL FIELD

The present invention relates to a robotic welding system.

### BACKGROUND ART

It is proposed to, in a robotic welding system for causing a robot to move a welding torch to weld steel plates, provide the robot with a sensor for detecting the size of a gap between the steel plates to be welded before the welding torch reaches the gap, and change a welding condition, for example, a welding current, a welding voltage, a wire feed speed or a welding torch movement speed, according to the size of the gap detected in advance (see, for example, Patent Document 1).

In the robot system described in Patent Document 1, a robot control apparatus includes: a welding condition table in which gap length ranges and welding conditions corresponding to the gap length ranges are recorded; an area in which a condition relaxation parameter is stored in advance as length information; and a condition relaxation calculation unit causing the welding condition to be changed by referring to a gap length currently detected by a sensor and the welding condition table in normal time, causing the current welding condition to be kept if the gap length currently detected by the sensor is smaller than a lower limit of a gap length range corresponding to the current welding condition in the welding condition table and is larger than a value obtained by subtracting a length specified by the condition relax parameter from the lower limit of the gap length range, and causing the current welding condition to be kept if the gap length currently detected by the sensor is larger than an upper limit of the gap length range corresponding to the current welding condition in the welding condition table and is smaller than a value obtained by adding the length specified by the condition relax parameter to the upper limit of the gap length range. In the system of Patent Document 1, it is possible to, by delaying a change in the welding condition, stabilize the welding condition when the gap amount changes in a short cycle.
Patent Document 1: Japanese Patent No. 5428136

### DISCLOSURE OF THE INVENTION

### Problems to be Solved by the Invention

It has turned out that, not only due to fluctuations in a short cycle dealt with by Patent Document 1 but also in the case of the gap amount having a significantly increasing or decreasing tendency and in the case of the welding speed being high, there is a possibility that appropriate welding cannot be performed only by causing welding conditions to be adapted to a change in the gap amount. Therefore, a robotic welding system is required that is capable of appropriately performing welding even when the gap amount significantly changes and even when the welding speed is high.

### Means for Solving the Problems

A robotic welding system according to one aspect of the present disclosure includes: a welding torch; a gap detector configured to detect in advance a gap amount between welding targets in front of the welding torch; a robot configured to move the welding torch and the gap detector; a controller configured to cause a welding condition to change based on the gap amount detected in advance by the gap detector; and a welding power source configured to execute welding based on the welding condition specified by the controller. Before the welding torch reaches a position at which the gap amount starts to exhibit an increasing tendency, the controller causes the welding condition to change according to an increase in the gap amount, and after the welding torch passes a position at which the gap amount starts to exhibit a decreasing tendency, the controller causes the welding condition to change according to a decrease in the gap amount.

### Effects of the Invention

A robotic welding system according to the present disclosure is capable of appropriately performing welding even when the gap amount is significantly changes and even when the welding speed is high.

### BRIEF DESCRIPTION OF THE DRAWINGS

FIG. 1 is a schematic diagram showing a configuration of a robotic welding system according to a first embodiment of the present disclosure;

FIG. 2 is a schematic diagram showing a relationship between a gap amount and a welding condition in the robotic welding system of FIG. 1; and

FIG. 3 is a schematic diagram showing a configuration of a robotic welding system according to a second embodiment of the present disclosure.

### PREFERRED MODE FOR CARRYING OUT THE INVENTION

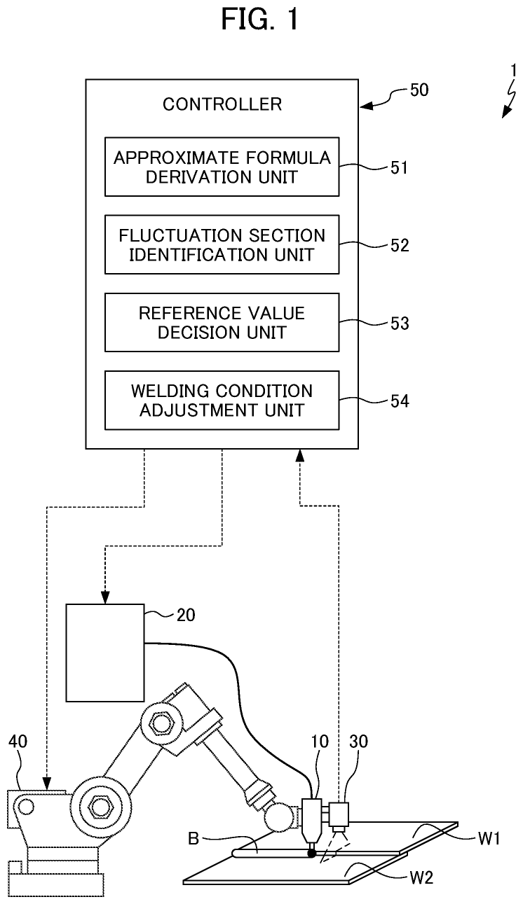

Embodiments of the present invention will be described below with reference to drawings. FIG. 1 is a schematic diagram showing a configuration of a robotic welding system 1 according to a first embodiment of the present disclosure.

The robotic welding system 1 is an apparatus that performs arc welding of a first welding target W1 and a second welding target W2. The welding targets W1 and W2 are typically steel plates and are arranged with facing faces of end portions thereof being overlapped or with the end portions being butted against each other. The robotic welding system 1 performs arc welding to form a weld bead B along one edge of each of the welding targets W1 and W2.

The robotic welding system 1 is provided with a welding torch 10, a welding power source 20 that supplies a welding current to the welding torch 10, a gap detector 30 that detects in advance a gap amount between the welding targets W1 and W2 in front of the welding torch 10, a robot 40 that moves the welding torch 10 and the gap detector 30, and a controller 50 that adjusts a welding condition based on the gap amount detected in advance by the gap detector 30.

As the welding torch 10, a welding torch that performs gas shield welding using a consumable electrode, for example, carbon dioxide gas arc welding, MIG welding or MAG welding is especially preferably used. A welding torch using a non-consumable electrode, for example, TIG welding may be used, and use of torches for other types of welding is also not excluded.

As the welding power source 20, a well-known power supply device that supplies a welding current for executing arc welding to the welding torch 10 can be used. It is preferable that the welding power source 20 is configured to be capable of adjusting the value of the welding current or welding voltage in real time according to a setting signal inputted from the controller 50 to be described later.

The gap detector 30 detects a gap between the first welding target W1 and the second welding target W2 in a thickness direction, that is, the height of the gap between the first welding target W1 and the second welding target W2 at a welding position. The gap detector 30 may also serve as a tracking sensor that detects a route on which the welding torch 10 should be moved, that is, a welding line position between the first welding target W1 and the second welding target W2.

The gap detector 30 detects a gap amount between the welding targets W1 and W2 in front of the welding torch 10 in a movement direction of the welding torch 10. A distance between a position of welding by the welding torch 10 and a position of gap detection by the gap detector 30 can be, for example, between 30 mm and 100 mm, including 30 mm and 100 mm.

As the gap detector 30, for example, a sensor that performs distance measurement by a laser beam by performing scanning in one direction is used. It is preferable that the gap detector 30 is held at a tip portion of the robot 40 to be described later, which moves the welding torch 10, so as to perform distance measurement by performing scanning in a direction vertical to the direction of movement of the welding torch 10 by the robot 40.

The robot 40 holds the welding torch 10 at an end portion that can change the spatial position and orientation. Thereby, the robot 40 can cause the welding torch 10 to move drawing a desired trajectory. It is preferable that the robot 40 holds the gap detector 30 together with the welding torch 10 as described above.

As the robot 40, a vertical articulated robot, a scalar robot, a parallel link robot, a Cartesian coordinate robot or the like can be used though the robot 40 is not especially limited. Further, depending on the shapes of the welding targets W1 and W2, the robot 40 may be a simple robot such as a positioner or an actuator that feeds the shaft in one direction or two directions by a linear motor or the like.

The controller 50 controls the behavior of the robot 40 to cause the welding torch 10 to move along a welding line between the first welding target W1 and the second welding target W2 and changes a welding condition so that the first welding target W1 and the second welding target W2 can be appropriately welded. As the welding condition changed by the controller 50, for example, a current value of a welding current supplied from the welding power source 20 to the welding torch 10, a voltage value of welding voltage similarly supplied, a movement speed of the welding torch 10 (a welding speed), a wire feed speed of the welding torch 10 and the like can be given. One or more of these can be changed by the controller 50.

The controller 50 can be realized by introducing an appropriate control program into one or more computer apparatuses each of which has a CPU, a memory and the like. Components of the controller 50 to be described later are classified functions of the controller 50, and may not be clearly classified in physical structure and in program structure. The controller 50 may include further components that realize other functions.

The controller 50 controls the robot 40 and the welding power source 20 based on a welding program created according to the shapes of the welding targets W1 and W2 and a gap amount detected by the gap detector 30. Before the welding torch 10 reaches a position at which the gap amount starts to exhibit an increasing tendency, the controller 50 causes the welding condition to change according to the following increase in the gap amount; and, after the welding torch 10 passes a position at which the gap amount starts to exhibit a decreasing tendency, the controller 50 causes the welding condition to change according to the preceding decrease in the gap amount. The terms “increasing tendency” and “decreasing tendency” mean that increase or decrease continue at a significant change rate, respectively.

The controller 50 can be configured to include an approximate formula derivation unit 51, a fluctuation section identification unit 52, a reference value determination unit 53 and a welding condition adjustment unit 54.

The approximate formula derivation unit 51 derives an approximate formula that approximates a change in the gap amount as a quadratic function of welding positions. Specifically, the approximate formula derivation unit 51 fits data of measured values of gap amounts at welding positions within a predetermined range around a welding position where checking is to be performed (hereinafter, referred to as a check position) by the least squares method, and thereby derives a quadratic approximate formula indicating a change in the gap amount near the check position. That is, when a welding position and a gap amount are indicated by D and P, respectively, the gap amount P near the check position is approximated as P=a×D²+b×D+c using coefficients a, b and c calculated by the least squares method.

The fluctuation section identification unit 52 identifies an increase section in which the gap amount is in the increasing tendency and a decrease section in which the gap amount is in the decreasing tendency, based on the approximate formula for each check position. As an example, the fluctuation section identification unit 52 can be configured to determine, first, whether the gap amount at the check position is in a decreasing tendency or an increasing tendency based on the quadratic coefficient a and a position of an extreme value (the minimum value or the maximum value) in the approximate formula and then determine a section in which the gap amount is continuously in an increasing tendency at welding positions and a section in which the gap amount is continuously in a decreasing tendency at welding positions as an increase section and a decrease section, respectively. In the fluctuation section identification unit 52, the minimum value of continuous amounts determined to be an increase section and a decrease section is appropriately set so that fluctuations of the gap amount in a short cycle due to measurement errors and the like can be excluded.

As a specific example, the fluctuation section identification unit 52 calculates a welding position at which the result of the approximate formula is an extreme value and can determine that the gap amount is in a decreasing tendency if the check position is on the left side of the extreme value (the value at the welding position is smaller), and the quadratic coefficient a is positive, that the gap amount is in an increasing tendency if the check position is on the right side of the extreme value, and the quadratic coefficient a is positive, that the gap amount is in an increasing tendency if the check position is on the left side of the extreme value, and the quadratic coefficient a is negative and that the gap amount is in a decreasing tendency if the check position is on the right side of the extreme value, and the quadratic coefficient a is negative. If the absolute value of the value of the quadratic coefficient a is small, it may be determined that the gap amount is neither in an increasing tendency nor in a decreasing tendency but is stable. In the fluctuation section identification unit 52, a value from which the gap amount is determined to be stable is set sufficiently small compared with the maximum gap amount that enables welding.

Since P′=2a×D+b, which is a derivative function of the quadratic function P, indicates a slope of P at the welding position D, the increasing/decreasing tendency may be determined using derivative function P′. The gap amount can be determined to be in an increasing tendency if P′ is positive and can be determined to be in a decreasing tendency if P′ is negative. If the absolute value of P′ is small, it may be determined that the gap amount is neither in an increasing tendency nor in a decreasing tendency but is stable. If the absolute value of P′ is large, it may be determined that the gap amount is significantly increasing or significantly decreasing.

The reference value determination unit 53 determines, for each welding position, a reference value for the welding condition according to the gap amount. The reference value for the welding condition is set as a value that enables optimal welding to be obtained when the gap amount is constant at an ideal value, that is, at a gap amount in the case of the first welding target W1 and the second welding target W2 being ideally in close contact. Specifically, the reference value determination unit 53 can be configured to determine the reference value for the welding condition for each welding position, for example, using a reference table in which gap amounts and reference values for the welding condition are associated, respectively, a conversion formula in which the welding condition is indicated by a function of gap amounts, or the like. When the movement speed (the welding speed) of the welding torch 10 fluctuates, the reference value determination unit 53 may determine the reference value for the welding condition for each welding position in consideration of not only the gap amount but also the welding speed. In general, when at least one of the gap amount or the welding speed increases, it is required to increase at least any of the current value of the welding current, the voltage and the wire feed speed.

The welding condition adjustment unit 54 determines a value of the welding condition for each welding position by moving values of reference values for the welding condition in an increase section backward in the welding direction (a position where welding is performed at earlier time) (overwriting values of the welding condition at movement-destination welding positions) and moving reference values for the welding condition in a decrease section forward in the welding direction. All the values of the welding condition between a movement source and a movement destination of reference values can be set to a value equal to the value of an end part of the moved data. At the end part of the movement destination of reference values on the tip side in the data movement direction, values of the welding condition can be discontinuous. However, such a significant change as influences welding does not happen if setting by the fluctuation section identification unit 52 is appropriate.

The controller 50 may include a movement amount setting unit by which a user sets in advance at least one of an amount of backward movement of reference values or an amount of forward movement of reference values by the welding condition adjustment unit 54. By providing the means for setting each movement amount, it is possible to adjust operation of the robotic welding system 1 so that more appropriate welding can be performed, according to external conditions such as thicknesses and materials of the welding targets W1 and W2. Further, for example, it is possible to make a setting that reference values are moved only in the case of an increasing tendency (backward movement) by setting the forward movement amount to 0 or only in the case of a decreasing tendency (forward movement) by setting the backward movement amount to 0.

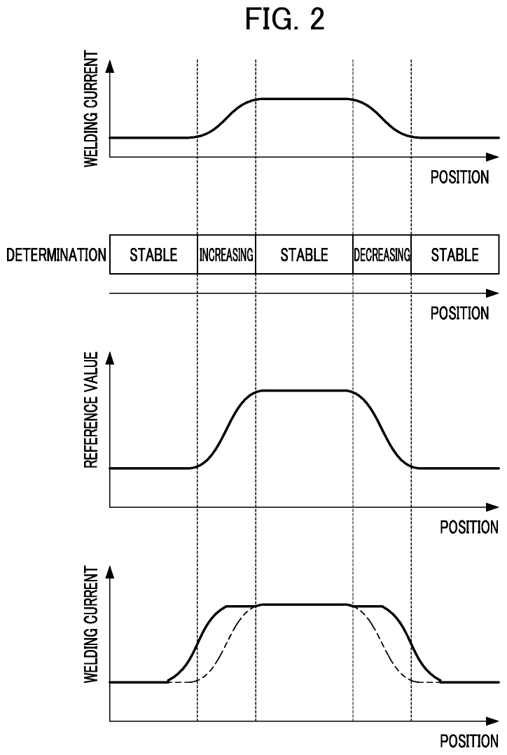

FIG. 2 shows, as an example, a relationship among the gap amount detected by the gap detector 30, an increase section, a decrease section and stable sections identified by the fluctuation section identification unit 52, reference values for the welding condition determined by the reference value determination unit 53 and final welding conditions adjusted by the welding condition adjustment unit 54, in a case of changing the current value of a welding current as the welding condition.

A waveform of reference values for the welding conditions for welding positions determined by the reference value determination unit 53 changes so as to match in position with a waveform of gap amounts detected by the gap detector 30. A section in which the slope of the waveform of gap amounts is equal to or more than a predetermined positive value is identified as an increase section; a section in which the slope of the waveform of gap amounts is equal to or less than a predetermined negative value is identified as a decrease section; and other sections are identified as stable sections.

The welding condition adjustment unit 54 determines the welding condition, that is, a waveform of current values of a welding current that the welding power source 20 should output, by moving reference values for the welding condition in the increase section backward, moving reference values for the welding condition in the decrease section forward, and interpolating values in sections in which values have disappeared due to the movements.

The state of welding at each welding position is influenced by welding conditions of immediately previous and immediately following welding positions. However, since the controller 50 having the above configuration increases an amount of deposition by adjusting welding conditions at positions immediately before and immediately after a welding position with a large gap amount, it is possible to prevent connection between the welding targets W1 and W2 from being loose. That is, the robotic welding system 1 is capable of appropriately performing welding even when the gap amount between the welding targets W1 and W2 is in a significantly changing tendency and when the welding speed is high.

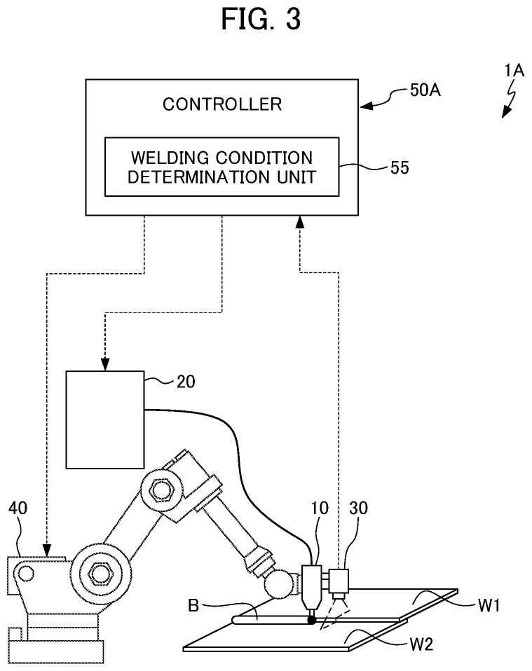

FIG. 3 is a schematic diagram showing a configuration of a robotic welding system 1A according to a second embodiment of the present disclosure. The robotic welding system 1A of FIG. 3 is used for a purpose similar to the purpose of the robotic welding system 1 of FIG. 1. For the robotic welding system 1A of FIG. 3, components similar to components of the robotic welding system 1 of FIG. 1 will be given the same reference numerals, and duplicate description may be omitted.

The robotic welding system 1A is provided with the welding torch 10, the welding power source 20 that supplies a welding current to the welding torch 10, the gap detector 30 that detects in advance the gap amount between the welding targets W1 and W2 in front of the welding torch 10, the robot 40 that moves the welding torch 10 and the gap detector 30, and a controller 50A that adjusts the welding condition of the welding power source 20 based on the gap amount detected in advance by the gap detector 30.

The controller 50A controls the behavior of the robot 40 to cause the welding torch 10 to move along a welding line between the first welding target W1 and the second welding target W2 and controls output of the welding power source 20 so that a welding condition that enables the first welding target W1 and the second welding target W2 to be appropriately welded is supplied to the welding torch 10. The controller 50A can be realized by introducing an appropriate control program into one or more computer apparatuses each of which has a CPU, a memory and the like.

The controller 50A controls the robot 40 and the welding power source 20 based on a welding program created according to the shapes of the welding targets W1 and W2 and a gap amount detected by the gap detector 30. Before the welding torch 10 reaches a position at which the gap amount starts to exhibit an increasing tendency, the controller 50A causes the welding condition to change according to the increase in the gap amount; and, after the welding torch 10 passes a position at which the gap starts to exhibit a decreasing tendency, the controller 50A causes the welding condition to change according to the decrease in the gap amount.

The controller 50A includes a welding condition determination unit 55 that determines a welding condition according to a maximum value of the gap amount within a predetermined set range that includes a welding position. The welding condition determination unit 55 checks gap amounts at welding positions within the predetermined range in the welding direction before and after a welding position to serve as a reference based on which a welding condition is determined, and causes a welding condition corresponding to the maximum value of the gap amount to be a welding condition at the welding position to be the reference.

When the gap amount starts to exhibit an increasing tendency in front in the welding direction, the welding condition determination unit 55 changes the welding condition according to the increasing gap amount as soon as possible in order to cause the welding condition to be a value corresponding to the maximum value of the gap amount within the set range. Even when the gap amount at a current welding position is in a decreasing tendency, the welding condition determination unit 55 does not cause the welding condition to change according to the gap amount before the decrease if the gap amount does not start decrease behind in the welding direction. Thereby, it is possible to prevent connection between the welding targets W1 and W2 from being loose at a welding position with a large gap amount and at a position where welding is performed at a high welding speed.

As for the size of the set range in which the maximum value of the gap amount is searched for, the size is set, for example, to a size that is twice the movement amount (once in front and once behind) of the welding torch 10 required to reach the amount of deposition (the magnitude of a bead) required when the gap amount is constant at an assumed maximum value. Thereby, the welding targets W1 and W2 can be certainly connected. When the movement speed of the welding torch 10 is included in welding conditions to be changed by the welding condition determination unit 55, the size of the set range may be set on the assumption that the movement speed of the welding torch 10 is the maximum.

The controller 50 may include a size setting unit that sets in advance the size of the set range so that the user can appropriately adjust the size of the set range according to external conditions such as the thicknesses and materials of the welding targets W1 and W2. The size of the set range may be settable to different sizes in front and behind, respectively, in the welding direction.

The welding condition determination unit 55 may adjust the size of the set range according to the welding speed. Specifically, the welding condition determination unit 55 may increase or decrease the size of the set range, that is, the length in the welding direction in proportion to the movement speed of the welding torch 10.

The embodiments of a robotic welding system according to the present disclosure has been described above. The scope of the present disclosure, however, is not limited to the above embodiments. Further, the effects described in the above embodiments are mere exemplifications of the most preferable effects that occur from the robotic welding system according to the present disclosure, and effects of the robotic welding system according to the present disclosure are not limited to those described in the above embodiments.

In the robotic welding system according to the present disclosure, a fluctuation component of the gap amount in a short cycle may be excluded using a moving average or the like instead of deriving an approximate formula. Further, in the case of determining a welding condition according to the maximum value of the gap amount in the set range, data from which the fluctuation component in a short cycle has been excluded by a moving average or the like may be used as the value of the gap amount at each welding position.

Further, in the robotic welding system according to the present disclosure, a welding power source may be any power source that executes welding based on a welding condition instructed by a controller and does not have to be a power source that directly supplies a current to a welding torch.

### EXPLANATION OF REFERENCE NUMERALS

1, 1A: Robotic welding system
10: Welding torch
20: Welding power source
30: Gap detector
40: Robot
50, 50A: Controller
51: Approximate formula derivation unit
52: Fluctuation section identification unit
53: Reference value determination unit
54: Welding condition adjustment unit
55: Welding condition determination unit
W1, W2: Welding target

1. A robotic welding system comprising:
a welding torch;
a gap detector configured to detect in advance a gap amount between welding targets in front of the welding torch;
a robot configured to move the welding torch and the gap detector;
a controller configured to cause a welding condition to change based on the gap amount detected in advance by the gap detector; and
a welding power source configured to execute welding based on the welding condition instructed by the controller; wherein
before the welding torch reaches a position at which the gap amount starts to exhibit an increasing tendency, the controller causes the welding condition to change according to an increase in the gap amount, and after the welding torch passes a position at which the gap amount starts to exhibit a decreasing tendency, the controller causes the welding condition to change according to a decrease in the gap amount.

2. The robotic welding system according to claim 1, wherein
the controller comprises:
an approximate formula derivation unit configured to derive an approximate formula that approximates a change in the gap amount as a quadratic function of welding positions;
a fluctuation section identification unit configured to identify an increase section in which the gap amount is in the increasing tendency and a decrease section in which the gap amount is in the decreasing tendency, based on the approximate formula;
a reference value determination unit configured to determine, for each of the welding positions, a reference value for the welding condition according to the gap amount; and
a welding condition adjustment unit configured to determine the welding condition for each of the welding positions by moving the reference value in the increase section backward and moving the reference value in the decrease section forward.

3. The robotic welding system according to claim 2, wherein
the fluctuation section identification unit identifies the increase section and the decrease section based on a quadratic coefficient and a position of an extreme value in the approximate formula.

4. The robotic welding system according to claim 2, wherein
the controller comprises a movement amount setting unit setting at least one of an amount of backward movement of the reference value or an amount of forward movement of the reference value.

5. The robotic welding system according to claim 2, wherein
the welding condition adjustment unit adjusts a movement amount of the reference value according to a movement speed of the welding torch.

6. The robotic welding system according to claim 1, wherein
the controller comprises a welding condition determination unit configured to determine the welding condition according to a maximum value of the gap amount within a predetermined set range that includes a welding position.

7. The robotic welding system according to claim 6, wherein
The controller comprises a setting unit configured to set in advance a size of the set range.

8. The robotic welding system according to claim 6, wherein
the welding condition determination unit adjusts a size of the set range according to a movement speed of the welding torch.
